(19) United States
(12) Patent Application Publication
(10) Pub. No.: US 2012/0141716 A1
(43) Pub. Date: Jun. 7, 2012

(54) Removable and Adhesable Checklist Notepad

(76) Inventor: Michelle Palmer, Falling Waters, WV (US)

(21) Appl. No.: 13/311,195

(22) Filed: Dec. 5, 2011

Related U.S. Application Data
(60) Provisional application No. 61/420,174, filed on Dec. 6, 2010.

(51) Int. Cl. B32B 33/00

(52) U.S. Cl. 428/42.3

(57) ABSTRACT

Disclosed is a peelable checklist notepad, comprising a plurality of tear away strips. The strips are arranged in layers of connected sheets, wherein each sheet provides a plurality of strips connected by separation lines for recording a top-down list of items. Each strip allows a user to write a particular task or item reminder for later reference. The backside of each strip comprises an adhesive surface, which connects the sheet layers together and allows individual strips to be removed and placed onto another surface for item reminder purposes. Each strip is removed by separating it along its boundary and further peeling it back from its adhered position against an underlying replacement strip. The underlying strip then replaces the removed sheet with a vacant location to record a checklist or reminder item.

### CROSS REFERENCE TO RELATED APPLICATION

This application claims the benefit of U.S. Provisional Application No. 61/420,174 filed on Dec. 6, 2010, entitled “Ripp Off Pads.”

### BACKGROUND OF THE INVENTION

1. Field of the Invention

The present invention relates to memorandum pads, checklist pads and reminder note pads. More specifically, the present invention relates to a checklist note pad with removable notes and a means for clearing completed tasks therefrom through physical removal.

Memorandum pads, checklists and sticky pads are useful for allowing a user to jot down lists of items or reminders for later reference. These items are generally tablets or bound notebooks wherein a writing surface is provided for the user to write any type of reminder, and alleviate the need for a user to remember all items by memory. Many people operate their business responsibilities and personal lives utilizing a checklist, wherein items can be listed in a top down fashion, prioritized and cataloged if necessary. The list allows a user to see what events or items are upcoming or those that require attention, and further allows the user to complete each task in a desired sequence. When a particular task is completed, the item is generally crossed out using a strikethrough notation, or the entire sticky pad reminder is discarded. In this way, the user can track his or her progress and ensure all tasks are being completed as required. Further, many users derive pleasure from accomplishing these preplanned tasks, as progress is measured towards completing all tasks, and is readily visualized.

The present invention pertains to a checklist pad and an improvement thereto, wherein a writing pad is provided with a plurality of locations to list items and reminders in a top-down list. A clear space is provided for each item, wherein a strip of writing material is positioned between boundaries defined by separation lines with respect to adjacent strips. The separation lines may comprise a perforated connection or cut lines that physically separate adjacent strips along their shared boundary. A page of strips comprise an entire sheet of strips for the user to list a series of items, reminders or to-do list items. As an item completed or no longer necessary, rather than crossing out or erasing the item, the strip upon which the item is written can be removed from the rest of the sheet. The individual strips are connected in-plane along the sheet, and along its backside using a readily removable adhesive to a backing of replacement strips. The top layer strip can be removed, therefore removing the item from the list, by peeling the strip away from its adhesive connection with a backside sheet and separating the strip along its perforation lines with adjacent strips. Once removed, the removed strip backside adhesive is still present and active, wherein the strip can be relocated to another surface if required. This is useful for creating quick reminders that can be placed on various surfaces for individuals to notice and take into account. If not required, the strip can be discarded. A strip may further be removed and placed in another location on the pad to prioritize items based on their position on the pad, whereby the adhesive allows the strips to be repositioned as required.

2. Description of the Prior Art

Checklist pads and memorandum pads have familiar design elements for the purposes of providing a user with a means of recording a list of items, reminders or to-do list items that the user would like to rely on for later reference. These items allow the user to record a list of items rather than relying on memory, preventing the case where an item goes uncompleted when otherwise forgotten. Current checklist pads include a plurality of locations for which to list items. Certain checklists further allow the user to remove and discard a checklist item once completed, which replaces the traditional method of crossing out the item using a strikethrough and utilizing a new checklist page when the first is full or all items are completed.

Another type of reminder article is a sticky note or adhesive notepad. These items allow a user to record an item or list of items on a writing note surface, wherein the note is removable from the remainder pad and its backing comprises a strip of adhesive. The note can be removed from its position on the pad and the adhesive can be utilized to adhere it to another object. This allows reminders and lists to be placed in various locations, wherein the entire note is removed from a larger pad for the purposes of placing the note elsewhere for reminder or notation purposes.

While these items are useful and are well suited for their particular requirements, they lack the ability to utilize both of their strengths without compromise. Checklist pads require the user to cross out items or remove the particular item strip from the rest of the notepad when completing an item on the checklist. Sticky note pads allow the user to write a note and remove an entire note surface from the remainder of the pad, which is helpful for relocating notes or placing a single checklist item on a sticky pad surface. However, these items are not adapted to perform the function of the present invention. The present invention is an improvement or combination of these items, which has not been previously disclosed or taught in the prior art. The present invention allows for a checklist pad that allows removal of singular checklist items amongst a larger list, and further allows that removed item to be adhered against another surface for reminder or notation purposes, similar to an entire surface of a sticky pad. In this way, individual items can be removed and replaced from a larger list of items, and further the item can be adhered to another surface to form a reminder or notice in a desired location. Once a strip is removed, an underlying strip is revealed to provide a fresh writing surface for the user.

Devices have been disclosed and patented in the prior art that describe either sticky not pads or checklist pads having removable strips. These devices share similar elements and provide a clear function, but fail to provide a combination thereof. Their common drawback lies in their construction, wherein a checklist pad is provided with removable strips, but it is merely disposable after removal thereof from the remainder of the list. While fulfilling a need in the art and meeting their respective requirements, these items fail to disclose the elements or spirit of the present invention. Examples of similar prior art devices are provided below. These devices are considered relevant to the present disclosure and a discussed individually to distinguish the elements of the present invention.

U.S. Pat. No. 814,699 to Hoey discloses a memorandum book comprising a plurality of leaves, or notation strips, that are removable from the rest of the book. The leaves are divided by parallel transverse slits that terminate at a plurality of ribbons at the book binding. The ribbons employ similar perforation lines to allow removal of each leaf and subsequent replacement thereof with an underlying leaf. The leave can be removed after a task is completed or a note is no longer necessary, wherein the removed leaf is discarded after separation from the book. The Hoey device discloses a removable checklist book having removable strips or leaves of notes. The Hoey device, however, fails to disclose an adhesive backing surface connection each sheet of leaves, which further allows the removed leaf to be adhered to another surface for notation or reminder purposes.

Similarly, U.S. Pat. No. 4,934,740 to Drake discloses a record book or pad comprising record sheets and removable sheets disposed in pairs. Each of the removable sheets has a line of weakness that allows that sheet to be torn or otherwise removed from the book binding. Cut lines between sheets similarly allow their removal from adjacent sheets. A low tack adhesive applied along a strip of the sheet with a width sufficient to extend from the spine part of each sheet over the line of weakness, allowing the sheet to be temporarily attached to a receptive surface remote from the book. The Drake device claims a removable sheet with a strip of adhesive along its line of weakness, which limits the adhesive area thereof for contact with a receptive surface. The present invention provides an elongated, removable strip with a continuous adhesive backing surface along a substantial portion thereof for application onto a remote surface.

U.S. Pat. No. 4,993,749 to Volk describes an inscribable memorandum book having rectangular tear out areas, wherein the tear out areas are surrounded by a supportive frame of paper retained around each sheet of areas. The sheets are bound together along their inner edges to create a plurality of bound sheets having removable areas. The Volk device, similar to the Hoey device, provides a removable book of disposable strips having no adhesive backing structure for placement onto a surface away from the book. The Volk device provides a supportive outer frame, but fails to disclose the elements of the present check list book having removable and adhesable strips.

U.S. Pat. No. 5,948,494 to Levin discloses a pad including a stack of composite sheets and a pad comprising a plurality of like composite sheets. A perforation line allows separation of the sheet into separate sheets, wherein the bottom surface thereof contains a pressure sensitive adhesive for placing the sheet in connection with a receptive surface away from the pad. The Levin device discloses a sticky note device that allows removal of a sheet of material from a larger pad. It is not adapted for use as a checklist pad, wherein a plurality of strips is provided to form a top-down list of items or reminders. Further, the adhesive on its bottom surface is limited to a portion of its surface, while the present invention provides a removable reminder or item strip with adhesive along a substantial area of its underside surface.

U.S. Pat. No. 5,328,409 to Marquardt discloses a note caddy having a binder with several sheets. The sheets include perforation scoring to facilitate remove thereof from the binder. Each sheet is adhered to a panel, whereby it can be removed and reapplied to another surface, while the panel is removable from the remaining sheet within the binder along perforation lines. The construction of the Marquardt device differs from the present invention. The Marquardt device employs a panel to support each removable sheet, while the present invention removable strips are directly applied to a subsequent backing strip that takes the removed strip location after removal. No extra backing surface or panel is necessary or desired behind each subsequent strip, rather the strips are directly overlaid upon one another prior to removal.

U.S. Pat. No. 4,043,573 to Griffin discloses a note pad formed of a plurality of stacked pages, wherein each page includes a means to distinguish each page from adjacent pages. Each page includes a series of detachable tabs, one for each section wherein a user records a to-do list item. By removal of the tabs, the user is able to visually scan the list of items and determine their status, as the absence of the tab is prominently displayed against a contrasting background. The Griffin device differs in structure and spirit from the present invention. While providing a novel means to track status for a list of items, its element differ from the present peelable checklist pad.

The present invention provides a readily removable plurality of strips adapted to receive a record or note, wherein the strips form a sheet of material in a top-down list format. Items are recorded onto each strip, wherein the strip can subsequently be removed from the sheet and therefore from the list of items. Each strip contains an adhesive backing surface that affixes to a replacement strip therebeneath. Once removed, the replacement strip may be recorded on for a new checklist item, and the removed strip may be placed against a receptive surface via the adhesive thereon. The order of strips may also be updated by repositioning the adhesive strips according to a desired priority. It is therefore submitted that the present invention substantially diverges in design elements from the prior art, and consequently it is clear that there is a need in the art for an improvement to existing peelable checklist notepad devices. In this regard the instant invention substantially fulfills these needs.

### SUMMARY OF THE INVENTION

In view of the foregoing disadvantages inherent in the known types of peelable checklist notepad devices now present in the prior art, the present invention provides a new peelable checklist notepad wherein the same can be utilized for providing convenience for the user when creating and maintaining a checklist without requiring strikethrough of completed items, and further placement of removed items on an external surface.

It is therefore an object of the present invention to provide a new and improved peelable checklist notepad device that has all of the advantages of the prior art and none of the disadvantages.

Another object of the present invention to provide a peelable checklist notepad comprising a plurality of removable strips having an adhesive backing surface, wherein each strip is removable and replaceable by a strip therebeneath.

Another object of the present invention is to provide peelable checklist notepad wherein a removed strip may be placed onto another surface for reminder or notation purposes, or further the order of strips along the pad may be updated to reflect a priority thereof.

Yet another object of the present invention is to provide peelable checklist notepad construction comprising only peelable strips, each adhered to a backing strip and distinguished from adjacent strips using separation line. The separation line comprises a perforated line of weakness or a discrete cut line separating adjacent strips.

A further object of the present invention is to provide peelable checklist notepad having several embodiments of construction, including separated strips having a common backing structure, perforated strips having no backing structure and finally a pad that includes strips attached to a common binder.

A final object of the present invention is to provide a peelable checklist notepad that can be formed in various sizes to accommodate different environments, such as larger notepads or smaller, pocket-sized notepads.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the present invention, wherein a plurality of strips provide areas for recording lists or notes.

FIG. 2 shows a view of a strip being removed from the rest of the notepad.

FIG. 3 shows a view of a removed strip being adhered to a receptive surface.

### DETAILED DESCRIPTION OF THE INVENTION

Reference is made herein to the attached drawings. Like reference numerals are used throughout the drawings to depict like or similar elements of the peelable checklist notepad. For the purposes of presenting a brief and clear description of the present invention, the preferred embodiment will be discussed as used for recording a list of items, wherein each item is recorded on a peelable strip that can be subsequently removed and applied to an external surface. The figures are intended for representative purposes only and should not be considered to be limiting in any respect.

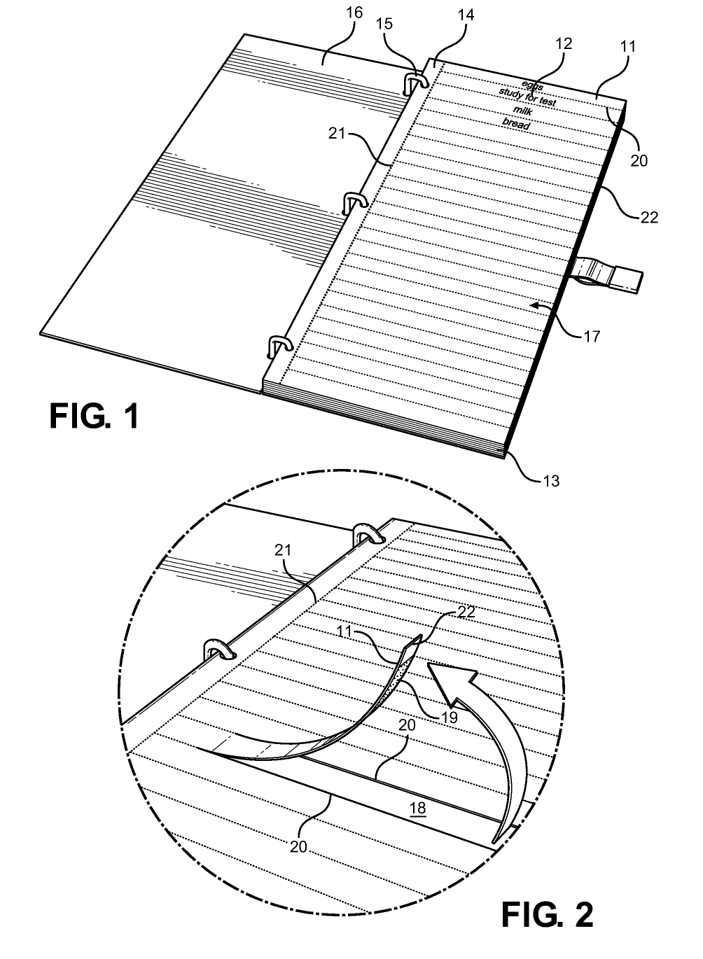

Referring now to FIG. 1, there is shown an overhead perspective view of the peelable checklist notepad of the present invention, wherein a plurality of peelable strips 11 is provided in a stacked 13 configuration. Each strip 11 comprises a top inscribable surface, boundary edges and an underside, adhesive surface. The strips 11 are configured in a notepad arrangement, wherein the strips 11 are aligned in a sheet to allow listing of items in a top down checklist. In a particular embodiment, each strip 11 is an elongated member that originates from a perforation line 21 at a common binding 14 and extends therefrom. Each strip 11 is aligned and shares common dimensions with adjacent and underlying strips, and configured in stacked arrangement. A user inscribes a note or checklist item 12 onto the top surface of a strip or set of strips. Once a task is completed, or a note is no longer required, it can be peeled away from the remaining stack for removal or relocation thereof.

The strips 11 are connected to adjacent strips via a separation line 20 that allows separation thereof. The separation line 20 is adapted to be a perforated connection or a discrete through-cut that separates adjacent strips. Along the underside surface of each strip is an adhesive that connects each strip to an underlying replacement strip. When removed, the outer edge of the strip 22 is peeled upward and pulled away from the underlying strip. The strip separates along its separation lines 20 with adjacent strips, and also is peeled from its underlying strip. The adhesive remains on the removed strip to allow the item to be placed onto an external receptive surface away from the notepad. In this way, the strips 11 form a sheet 17 of inscribable writing surfaces, wherein individual items may be removed from the sheet 17 as desired without strikethrough notations or erasure. The strips 11 may further be placed on top of another strip, allowing the user to reorganize or prioritize a list of items by updating their top-down position on the pad.

It is desired to disclose embodiments of the peelable checklist notepad that include alternate means of retaining or covering the notepad. Specifically, in an exemplary embodiment, a binding 14 is utilizes as a common juncture for all strips in the pad. The binding 14 can be attached to a plurality of rings 15 that connect a pad cover 16 thereto, allowing notes and checklist items 12 to be covered and protected if desired. Other embodiments may forgo the use of a cover, and utilize only the common binding 14 to secure each strip without supplying a covering thereto. It is also desired to disclose embodiments of the notepad that encompass different sizes and shapes, wherein a longer list with a greater count of elongated strips is provided, or alternatively a shorter checklist with few strips, further having strips of shorter length, is provided in a more convenient, pocket-sized notepad for the user to transport.

Referring now to FIG. 2, there is shown a strip 11 being peeled and removed from the notepad, along with a closer visualization of the construction of the notepad. As shown, the strip comprises an elongated section of inscribable material, wherein the strip 11 has an upper writing surface, an underside adhesive surface 19 and boundary edges that form connections along separation lines 20 and a distal end 22 of the strip forming a free edge of the stack of strips. To remove a strip 11, its distal end 22 is peeled away from an underlying strip 18 to separate the adhesive bond therewith, as well as initiate separation with adjacent strips along their common separation line 20. It may be desired to leave a section along the strip length in proximity to its distal end 22 unattached with an adjacent strip or underlying. This facilitates improved grasping of the end of the strip, lifting and initial peeling thereof without requiring the user to grasp, peel and break perforation lines simultaneously. Once the strip is peeled along its length and is completely separated from adjacent strips, the strip can be removed from its binding 21 along a perforation line for complete removal thereof. Once removed, the strip can be discarded or placed onto another surface as desired.

Each strip 11 is directly connected to underlying replacement strips 18, the plurality of strips aligned in a stack and bounded by adjacent strips to form an entire pad. No extra material is desired between strips or therebetween, such as a backing film, boundary or frame. In an embodiment of the pad, the binding may be absent, wherein the strips form the structure of the pad. This embodiment includes strips having two free edges to grasp and initiate peeling from either end thereof. This embodiment eliminates any binding and therefore any external cover, but simplifies the pad significantly and allows peeling from each either of the strip. The separation lines 20 between strips may be formed of a perforated connection or a complete through-cut between strips. The perforated connection provides improved connection between adjacent strips, but requires the user to break the bond of adhesive and simultaneously break the perforation line of weakness. A through-cut separation line 20 requires a backing structure along the back of the pad, wherein the lower-most strips are supported by a common, rigid support. The support holds the separated stacks of pads in their adjacent configuration, wherein they would otherwise easily separated and form independent stacks of strips.

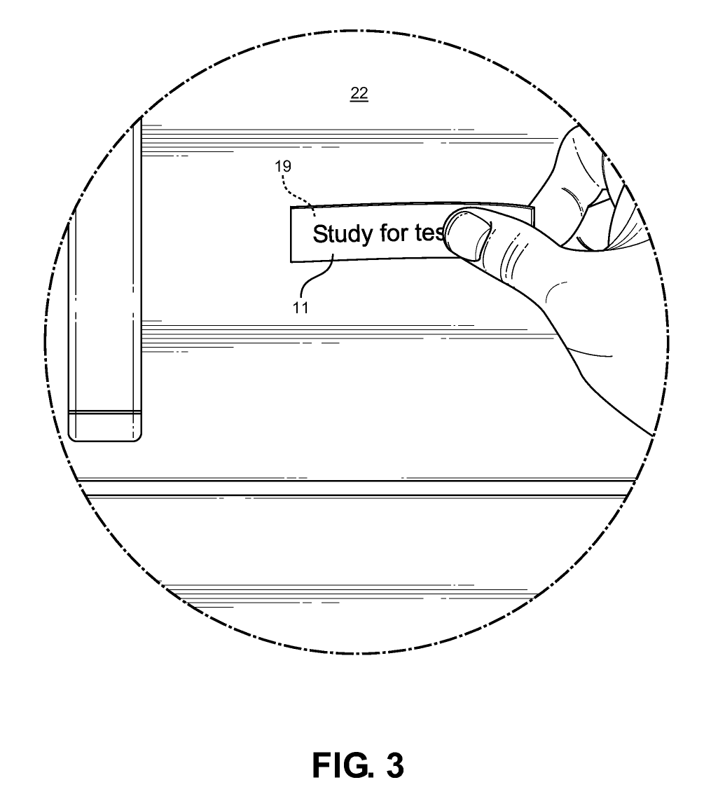

Referring now to FIG. 3, there is shown view of a strip 11 as described by the present disclosure after its removal from the stack of strips. As shown, the strip 11 adhesive backside surface 19 can be pressed onto a receptive surface for placement of the strip thereon. In this way, a strip 11 can be removed from the list of items after completion or if a reminder note is necessary, and the strip 11 may be applied directly onto an external surface. The inscribed note is therefore placed where desired for reminder or notation purposes. This feature broadens the utility of the disclosed pad, as the features of a sticky note and a removable checklist pad are disclosed, wherein the pad functions as either or both of these devices.

It is desired that the adhesive backing extend across a majority of the strip surface, rather than along a smaller area thereof. The strips comprise an entire stack of connected strips, wherein adequate connection between outer and underlying strips is necessary to maintain the structure of the pad. The devices in the prior art disclose smaller sections of backside adhesive and pads of differing construction, which does not provide adequate connection with a receptive surface after an extended period, and fails to provide a means to connect the disclosed strips into a stack as described herein.

The backside adhesive is preferably a pressure sensitive adhesive, while the strip is an inscribable material of sufficient weight to allow peeling from the rest of the pad and separation along perforation lines without compromising the strip integrity through tearing thereof along its length. The strip is constructed of a thick material that is adapted to allow a swift peeling motion without regard to the strip structural integrity or tensile strength, wherein tearing of the strip would otherwise occur if the strip is swiftly grasped, lifted and peeled from the notepad.

Overall, the disclosed pad is an advancement of the art in the field of checklists and removable strip notepads. The device comprises a means of facilitating the functions of both a sticky note reminder pad and a checklist pad with removable line items thereon. The device is preferably constructed of only removable strips, wherein each strips is in connection with adjacent and underlying strips, and the removed strips may be adhered to external surfaces, reordered on the pad or discarded after use. Once removed, an underlying surface takes the place of the removed strip to provide a clean, unmarked writing surface for placement of a new note or checklist item. This cycle continues until all strips are removed from a certain area on the pad, wherein eventually all strips will be exhausted and removed.

It is therefore submitted that instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A peelable checklist notepad, comprising:
a plurality of peelable, inscribable strips arranged in a top-down list and stack of strips;
each strip comprising a top inscribable surface, an underside adhesive surface and boundary edges;
said strips separable from adjacent strips along a separation line along said boundary edges, and stacks of said sheets formed via connection of said underside adhesive surface with underlying strips;
said strips being peelable from underside strips and removable along said separation lines, said strip underside adhesive surface permitting placement of a removed strip onto an external receptive surface or elsewhere on the pad;
said adhesive extending along a majority of said strip underside surface.

2) The device of claim 1, wherein said strips further comprise a first distal end that is absent of adhesive along its underside surface and disconnected from adjacent strips to facilitate grasping and initial peeling thereof.

3) The device of claim 1, wherein said strips further comprise perforated connection with a common binding along an end of said strips.

4) The device of claim 3, wherein said binding further provides connection to a notepad cover.

5) The device of claim 1, wherein said strips further comprise a first and second distal end that is absent of adhesive along its underside surface and disconnected from adjacent strips to facilitate grasping and initial peeling thereof from either end of said strip.

6) The device of claim 1, wherein said separation lines are perforated connections with adjacent strips.

7) The device of claim 1, wherein said separation lines are through-cut separations between adjacent strips, said stack of strips supported by a common backing structure to retain their position as a stack of adjacent strips.
